(19) United States
(12) Patent Application Publication
(10) Pub. No.: US 2025/0282680 A1
(43) Pub. Date: Sep. 11, 2025

(54) CONCRETE ADMIXTURE MADE WITH RECYCLED WASTE MATERIALS CONTAINING SUPER ABSORBENT POLYMERS AND ASSOCIATED METHODS

(71) Applicant: Purdue Research Foundation, West Lafayette, IN (US)

(72) Inventor: Kendra Erk, West Lafayette, IN (US)

(21) Appl. No.: 19/076,719

(22) Filed: Mar. 11, 2025

Related U.S. Application Data
(60) Provisional application No. 63/563,760, filed on Mar. 11, 2024.

(51) Int. Cl. C04B 18/02; C04B 16/06; C04B 18/20; C04B 18/24; C04B 103/00; C04B 103/46

(52) U.S. Cl. CPC C04B 18/021; C04B 16/0633; C04B 18/20; C04B 18/24; C04B 2103/0051; C04B 2103/465

(57) ABSTRACT

Admixtures for concrete, concrete including admixtures, and methods of making admixtures for concrete and making concrete using the admixtures. Such an admixture includes a dry mixture of a silica-based binder and recycled waste material, the latter including at least one of post-consumer waste and/or post-manufacturing waste containing superabsorbent polymer particles and cellulosic particles. The admixture typically is provided in a dry powder form. The recycled waste material may be absorbent hygiene products, such as disposable diapers and/or feminine hygiene products.

### CROSS-REFERENCE TO RELATED APPLICATIONS

This application claims the benefit of provisional U.S. Patent Application No. 63/563,760 filed Mar. 11, 2024, the contents of which are incorporated herein by reference.

### BACKGROUND OF THE INVENTION

The invention generally relates to admixtures for concrete, concrete containing such an admixture, and methods of making an admixture for concrete and making concrete using the admixture.

Concrete is produced with concrete mixtures that are generally understood to comprise a cementitious material (a cement or cement mixture) and one or more aggregates that, during curing of the concrete, are adhered together by a matrix of cured cement formed by the cement mixture. Concrete mixtures that are cast and printed into complex structures can prematurely dry out as they are curing due to water loss (evaporation) to the surrounding environment. Such premature drying results in a volumetric shrinkage of the concrete as it cures, called drying shrinkage, which in turn results in the development of stress cracks and a corresponding decrease in compressive strength and durability of the final hardened (cured) concrete product. The problem of premature water evaporation, drying shrinkage, and the subsequent cracking of cast and printed concrete is exacerbated in hot, sunny weather and in arid climates due to higher evaporation rates. In addition, “high performance” and “ultra-high performance” concrete mixtures, which contain even less water than conventional concrete mixtures, can also prematurely dry out during setting and curing due to self-desiccation, which refers to drying caused by the chemical reactions between the cement mixture and water during hydration, and thereby undergo autogenous shrinkage.

Admixtures are sometimes added to concrete mixtures to reduce or eliminate self-desiccation and subsequent autogenous shrinkage of cast high and ultra-high performance concrete mixtures. Some conventional concrete admixtures utilized in concrete mixtures include water-filled internal curing agents in the cement mixtures, such as light weight aggregate (LWA) particles and superabsorbent polymer (SAP) particles. The water in these internal curing agents is subsequently released into the cement mixture during curing of the concrete, which reduces the self-desiccation and related volumetric shrinkage during curing. In addition, concrete admixture with surfactant-based shrinkage reducing agents have also been used to limit the loss of water to the environment, and viscosity modifying admixtures have been used to reduce the bleeding of water from the concrete mixture. The use of dry silica fume and other nanosilica materials in water-based solutions or suspensions is also an established strategy to promote the growth of calcium silicate hydrates (C-S-H) in cement mixtures. As known in the art, C-S-H is the strong cementitious “glue” that binds together the fine and coarse aggregate in concrete, forming a stronger and denser cement matrix that results in a cured concrete with greater strength and durability.

In one example, U.S. Pat. No. 10,752,547 discloses SAP hydrogel-based internal curing agents for cement mixtures in which the curing agents include a superabsorbent poly (acrylamide (AM)-acrylic acid (AA)) hydrogel having pozzolanic particles chemically incorporated directly into the polymer macromolecular network structure of the hydrogel. These curing agents exhibit increased reactivity and impart greater strength and durability to cured cement. However, the use of these particles in printed concrete mixtures is limited, and there are no major producers of SAP for the construction industry. In addition, most plastic-based admixtures are typically derived from fossil fuels, which can be expensive and increase the carbon footprint of such concrete.

Therefore, it would be desirable to have concrete admixtures that are preferably capable of reducing self-desiccation and related volumetric shrinkage during curing of concrete mixtures and imparting strength and durability to a cured cement, while preferably also containing constituents that are readily available and/or can reduce the overall carbon footprint of the concrete curing process.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, admixtures for concrete, concrete including such an admixture, methods of making admixtures for concrete, and methods of making concrete using such admixtures.

According to a nonlimiting aspect, an admixture for concrete includes a mixture of a silica-based binder and recycled waste material comprising superabsorbent polymer particles and cellulosic particles. The admixture is in a powder form. In some embodiments, the recycled waste material may include post-consumer waste and/or post-manufacturing waste, including, for example recycled absorbent hygiene products, such as recycled disposable diapers.

According to another nonlimiting aspect, a concrete mixture includes a cementitious material, an aggregate, and an admixture made of a mixture of a silica-based binder and recycled waste material comprising superabsorbent polymer particles and cellulosic particles.

According to yet another nonlimiting aspect, a method of manufacturing an admixture for concrete includes obtaining a curing agent material containing a recycled waste material including superabsorbent polymer particles and cellulosic particles, forming a mixture of the curing agent material with a silica-based binder, and forming a dry powder from the mixture that dissolves and reacts when incorporated as an admixture into a fresh (wet) concrete mixture.

According to still another nonlimiting aspect, a method of making concrete includes mixing a cementitious material, an aggregate, and an admixture disclosed herein with water to form a fresh (wet) concrete mixture, and curing the fresh concrete mixture. The admixture absorbs and releases water during the curing.

Technical aspects of admixtures as described above preferably include the ability to provide a curing agent material that is more readily available, and/or recycles and/or reuses post-consumer and/or post-manufacturing wastes, and/or can reduce the overall carbon footprint of concrete using such curing agent materials.

These and other aspects, arrangements, features, and/or technical effects will become apparent upon detailed inspection of the figures and the following description.

### BRIEF DESCRIPTION OF THE DRAWINGS

FIG. 1 represents a method of making an admixture for concrete according to some nonlimiting aspects of the invention.

FIG. 2 represents conventional product life cycle flow contrasted with a recycling flow of SAP-containing products according to some nonlimiting aspects of the invention.

FIG. 3 is a schematic cross-sectional diagram showing common layers of a typical conventional disposable diaper.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects described as part of a particular embodiment could be eliminated, and also encompasses additional or alternative embodiments that combine two or more features or aspects described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

To address problems with premature drying of concrete previously described herein, in some nonlimiting aspects of invention, a cement admixture contains a curing agent material that includes recycled waste materials, particularly post-consumer waste (PCW) and/or post-manufacturing waste (PMW; also referred to herein as “post-industrial waste”) obtained from absorbent hygiene products (AHP) that contain superabsorbent polymer (SAP) particles, which are hydrogel-based and capable of absorbing and releasing water during curing of a concrete mixture into which the cement admixture has been incorporated. The inclusion of the curing agent material is preferably capable of decreasing the volumetric shrinkage of the concrete mixture during curing, decreasing the formation of stress cracks, and thereby increasing the compressive strength and service life of the hardened (cured) concrete mixture. Hydrophilic plastic and cellulosic particles, polypropylene fibers, pulp, and fibers that may be present in the curing agent material modify the viscosity of the uncured (also referred to herein as “fresh” or “wet”) concrete mixture to limit material segregation and water bleeding, for example, during printing and casting of the uncured concrete mixture. These hydrophilic particles also reduce evaporation of water to the surrounding environment.

The cement admixture also contains a silica-based binder, for example, silica particles and/or organic silicate molecules, that are present in the admixture to promote the growth of calcium silicate hydrates (C-S-H), which as previously described serves to bind together aggregate particles in concrete, promotes a stronger and denser cement matrix, and results in a cured concrete with greater strength and durability.

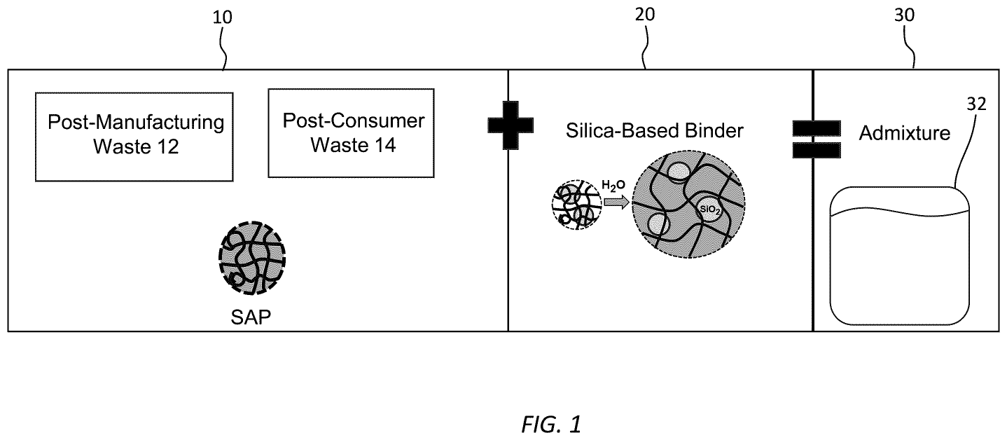

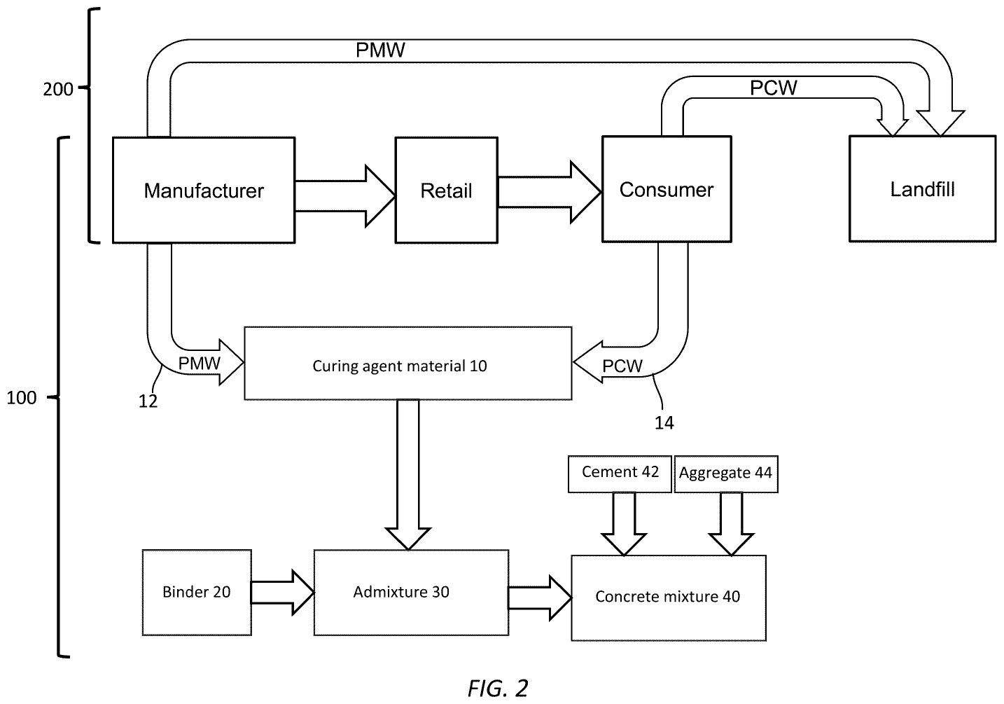

FIGS. 1 and 2 schematically represent nonlimiting examples of producing the cement admixture 30 to contain a curing agent material 10 that includes a recycled waste material derived from at least one of post-consumer waste (PCW) and/or post-manufacturing (post-industrial) waste (PMW) (collectively, “recycled waste material(s) 12/14”) so as to contain superabsorbent polymer particles. As illustrated in FIG. 1, a curing agent material 10 derived from PMW 12 and PCW 14, such as absorbent hygiene products, is combined with a silica-based binder 20, and optionally other concrete additives as discussed hereinafter, to form the cement admixture 30. The cement admixture 30 is preferably incorporated into a concrete mixture 40 in a powder form. For example, components of absorbent hygiene products such as recycled disposable diapers (PCW and/or PMW) can be used to create the curing agent material 10 in the form of a dry powder that increases the hydration and modifies the viscosity of the concrete mixture 40 while simultaneously strengthening the cement matrix formed by curing a cementitious material (cement) 42 present within the concrete mixture 40. Such a curing agent material 10 may also reduce workplace hazards. As represented in FIG. 2, a stream 100 used to produce the curing agent material 10 differs markedly from a conventional stream 200 in which PMW 12 from a manufacturer is placed directly in landfills and PCW from consumers of goods purchased from a manufacturer through retail channels is also placed in landfills.

In contrast to using some conventional concrete additives for curing agents, the admixture 30 that contains the curing agent material 10 derived from PMW 12 and/or PCW 14, particular if derived from recycled diaper components, may be capable of forming concrete with greater strength and durability that would require less repair and replacement over time. Such curing agent materials 10 are also preferably capable of providing significant reductions of greenhouse gas emissions, for example, by reusing materials instead of using virgin additives derived from fossil fuels, and/or by decreased landfilling and incineration of discarded and waste disposable diaper components. The energy and economic savings of a concreate admixture that contains disposable diaper components are expected to be significant for manufacturers and builders alike, as making the absorbent and fiber components of disposable diapers is typically the most cost and energy intensive processing step.

As represented in FIGS. 1 and 2, the curing agent material 10 is preferably combined with a silica-based binder 20 to create the admixture 30. The admixture 30 is preferably in powder form (i.e., an “admixture powder”) whose particles are able to dissolve and react when incorporated into the concreate mixture 40, which is typically a fresh (wet) concrete mixture 40 containing a cementitious material (cement) 42 and an aggregate 44. The admixture 30 acts as an internal curing agent and a viscosity-modifying additive that is capable of creating low-carbon and low-water concrete structures with good strength and service life. As represented in FIG. 1, powders of the admixture 30 may be packaged in easily used packaging, preferably a water-soluble container 32 such as one-pound (0.45 kg) dissolvable bags 32, for easy batching into a fresh concrete mixture, such as in a stationary concrete mixer on a job site or in a conventional concrete mixer truck.

In addition to disposable diapers, the PMW 12 and PCW 14 utilized in the curing agent material 10 may come from the manufacture and/or use of additional or other disposable absorbent hygiene products (AHP), such as incontinence products and feminine care products (i.e., tampons, menstruation pads, etc.). The PMW 12 may include scrap diapers and biproduct materials that are created during the industrial manufacture of disposable diapers, such as scrap materials, products out of specification, and/or rejected products. The PCW 14 may include soiled diapers, incontinence products, and feminine care products that are discarded by consumers, such as refuse, soiled, and/or unused products. The PMC 12 and PCW 14 may be mixed together in various fractions to form a single multifunctional curing agent material 10. Alternatively or in addition, PMW 12 may be formed into the curing agent material 10 separately from the PCW 14. In the latter case, the increased purity and homogeneity of post-manufacturing waste (i.e., uniform chemical composition, narrow particle size distribution, controlled density) may be used to create additives with optimized performance for higher-value, higher-strength concrete mixtures, such as, high- and ultra-high-performance concrete used in bridge decks. The more heterogeneous mixture of particles and fibers that typically result from the post-consumer waste streams may be used to create additives for high-volume concrete applications, such as pavements and sidewalks. Typically, although not necessarily, the curing agent material 10 will contain fractions of plastic and cellulosic particles, fibers, and pulp, including superabsorbent polymer particles, polypropylene fibers and films, and cellulose-based absorbent granular media.

Materials for the curing agent material 10 may be recycled and/or preprocessed by being decontaminated, washed, and dried, as needed. For example, if the recycled waste material 12/14 is a PCW 14, then it likely needs to be decontaminated and washed. However, if the recycled waste material 12/14 is a PMW 12, then it may not be necessary to decontaminate or wash it. After any such preprocessing, the recycled waste material 12/14 is then processed into smaller particles to form a powder. Suitable size-reduction processes can include, for example, shredding and cutting the recycled waste material 12/14 into small particles to promote ease of mixing and blending. For example, the recycled waste material 12/14 may be processed into particles whose largest dimensions are less than 10 mm, such as about 0.1 mm up to less than 10 mm or a subrange therebetween, for example, about 0.2 to about 5 mm or about 0.5 to about 2 mm, although it is foreseeable that smaller or larger particles may be used.

Thereafter, the processed and sized-reduced particles of the recycled waste materials 12/14 are mixed with the binder 20 to create dry particle aggregates (powders) that form the admixture 30. Some nonlimiting examples of suitable binders 20 include solid and/or liquid forms of sodium (meta) silicate, silicon dioxide particles, organic silicate binders, and other silica-based binders, including organosilanes (e.g., an organoalkoxysilane or organohalosilane), as well as silica fume as a grinding aid. In some embodiments, existing PMW 12 and PCW 14 can be converted into flowable powders with a target average particle size of about 100 to about 300 micrometers to promote effective internal curing of the cement matrix formed by the admixture 30. To achieve this target, recycled, preprocessed, and/or processed PMW 12 and PCW 14 obtained from commercial sources may be ground and/or bound in the presence of solid and/or liquid sodium silicate and/or other silica-based grinding aids or binders, to reduce and/or increase the particle size. Optionally, one or more other active agents, such as light weight aggregate (LWA) particles, silica fume, other shrinkage reducing and viscosity modifying admixtures, may also be incorporated into the admixture 30 and/or added to the mixed into the curing agent material 10 separately. As illustrated in FIG. 2, the concrete mixture 40 will also typically contain a cementitious material (cement) 42 and an aggregate 44 that may be directly combined to form the concreate mixture 40, though it may be acceptable to incorporate the aggregate 44 into the admixture 30.

In some nonlimiting examples, the admixture 30 may include any one or more of at least the PMW 12, the PMW 12 mixed with other components, the PCW 14, the PCW 14 mixed with other components, binders, and grinding aids. The PMW 12 typically includes a majority of absorbent SAP particles that are obtained, for example, from manufactures of absorbent hygiene products. The SAP particles are typically about 1 to about 600 micrometers in diameter (largest cross-sectional dimensions) when dry. Because particles this small can sometimes cause clumping and inhomogeneous dispersion of the particles through a fresh (wet) concrete mixture 40, it may be desirable to increase the particles size somewhat. To accomplish this, a silica-based binder may be used to bind the smaller particles together into a larger aggregate to increase the particle size and ensure good dispersion of the particles throughout the concrete mixture 40, as discussed in further detail below.

The PMW 12 mixed with other components will typically include absorbent SAP particles mixed with other components, such as cellulose and/or other plastics in the forms of particles and fibers from the manufacture of absorbent hygiene products. These particles are typically about 1 to about 3000 micrometers in diameter when dry. Similar to the PMW 12, a silica-based binder may be used to bind the smaller particles together into a larger aggregate to increase the particle size and ensure good dispersion of the particles throughout the fresh concrete mixture.

The PCW 14 typically includes mixed waste materials from consumer use of absorbent hygiene products. These particles are typically about 1 to about 10,000 micrometers in diameter when dry. This larger average particle size and size distribution may in some instances disrupt the cementitious microstructure of a cement matrix formed by curing the concrete mixture 40 in a way that results in reduced mechanical strength. To ameliorate this, a silica-based mechanical grinding aid may be added to reduce the size of the larger particles within the PWC 14, as discussed in further detail below.

The silica-based binder 20 preferably transforms the PMW 12 and/or PMW 14 into a flowable powder with particle sizes ranging from about 100 to about 1000 micrometers. Silica-based binders 20 may be incorporated into the admixture 30 in various ways. For example, the silica-based binder 20 may be added to the admixture 30 in the form of a sodium metasilicate aqueous solution and/or in the form of an aqueous solution containing another pozzolanic, silica-based material, such as silica fume, nanosilica, calcium silicate, blast furnace slag, and/or silica-containing biochar sources (bamboo, rice, corn). Other methods and forms of incorporating the silica-based binder 20 into the admixture 30 may be used.

A silicate-based grinding aid may be added to the admixture 30 to reduce the size of larger particles within the admixture 30. The silicate-based grinding aid may include a solid form of sodium metasilicate and/or another pozzolanic, silica-based material, such as silica fume, nanosilica, calcium silicate, blast furnace slag, and/or silica-containing biochar sources (bamboo, rice, corn). This mechanical grinding aid may be used, for example, to transform larger particles of PCW 14 into a flowable powder with particle sizes ranging from 100 to about 1000 micrometers.

If the superabsorbent polymer particles derived from the PMW 12 and/or PCW 14 are too large in size when swollen with water, they typically result in large internal voids in the cement matrix after fluid desorption, which can reduce the strength of the resulting concrete. However, if the superabsorbent polymer particles are too small, they may not easily mix and disperse through a fresh concrete mixture, resulting in large clumps of dry powders that will decrease the strength of the resulting concrete. Additionally, for traditional mechanical reinforcement of concrete, such as fiber reinforced concrete, additive particles that are too large are more likely to reduce the strength of the concrete due to disruption of the cement matrix, for example, increasing the porosity in the matrix-aggregate interfacial transition zone, and additive particles that are too small typically are not effective for mechanical reinforcement. Therefore, it is believed that providing the admixture 30 in a free-flowing powder form with an approximate particle size range of about 100 to about 5000 micrometers, and more preferably in the range of about 100 to about 1000 micrometers, will achieve the greatest overall performance. To achieve these size ranges, recycled waste materials that contain a majority of small particles (less than 600 micrometers) can be transformed into larger powders by mixing the waste materials with the silica-based binder 20, and recycled waste materials that contain a majority of larger particles (larger than 600 micrometers) can be transformed into smaller powders by milling the waste materials with the silicate-based grinding aid.

Silica and other pozzolanic materials, such as silica fume, are commonly added to concrete mixtures to encourage the formation of C-S-H bonds to increase the strength and durability of the concrete. The silica present in silica-based binders and/or silicate-based grinding aids can therefore at least partly be incorporated into the concrete mixture as a component of the admixture 30. Advantageously, the presence of the various PMW 12 and PCW 14 within the admixture 30 are believed not change the chemical activity of the silica. Thus, the silica within the silica-based binder 20 and/or mechanical silicate-based grinding aid incorporate into the cement matrix and facilitate the growth of C-S-H to ultimately form a stronger and more durable concrete.

Following the creation of the dry particle aggregates (powders), pre-measured charges of the admixture 30 are optionally enclosed in water-soluble (dissolvable) containers 32, such as dissolvable bags 32 of appropriate sizes capable of rapidly dissolving when placed into a fresh (wet) concrete mix, as a nonlimiting example, three-pound (about 1.4 kg) bags or one-pound (about 0.45 kg) bags. For example, in one embodiment, the bag 32 is a 6″×5″ (15 cm×13 cm) dissolvable bag containing one pound (0.45 kg) of the admixture 30 for adding to 1 cubic yard (765 L) of uncured concrete mixture. Bags 32 of these weights and sizes are readily capable of being manually handled for manual incorporation into a concrete mixture undergoing mixing in a stationary mixer at a job site or a concrete mixer truck at a cement batching facility.

In use and as represented in FIG. 2, the admixture 30 is added and thoroughly mixed into a fresh concrete mixture 40 by any convenient method. If the admixture 30 is provided in a water-soluble packaging container, such as the dissolvable bag(s) 32, the entire bag 12 containing the admixture 30 may be simply added to the fresh concrete mixture 40 so that the bag 32 will be dissolved by the water in the concrete mixture 40. After the bag(s) 32 dissolves and particles of the admixture 30 are released into the wet concrete mixture 40, particles of the admixture 30 mix into the mixture 40. The particles then begin immediately reacting with the water in the concrete mixture 40. The concrete mixture 40 containing the admixture 30 is then mixed to uniformly disperse the admixture 30 throughout the concrete mixture 40 (including any aggregate 44 therein) and interact with the alkaline water (pore fluid) and particles.

The curing agent material 10 containing superabsorbent polymer particles can be sourced from many different products and/or sources, and the present invention is not specifically limited to incorporating any single particular source or type of such waste material. However, of particular interest is the recycling of PCW 14 and PMW 12 arising from disposable diapers, incontinence products, feminine hygiene products, and similar disposable absorbent hygiene products. Disposable diapers (and other similar absorbent hygiene products) are typically made primarily of various polymeric materials, cellulose, superabsorbent polymers, and fluff cellulose pulp, and are designed to be used only once and thereafter thrown away as waste. As such, unlike classic cloth diapers, disposable diapers are not suitable to be washed and/or reused after having soaked up bodily (or other) fluids. It is well known that disposable diapers are a significant source of non-biodegradable landfill volume. When dumped in landfills, disposable diapers impose serious environmental threats and health hazards. If incinerated, disposable diapers emit methane gas and hence contribute towards greenhouse effect. Moreover, disposable diapers are made mostly of pulp and plastic, both of which use large quantities of non-renewable resources in their manufacturing processes. As such, a desirable benefit of the admixture 30 in some nonlimiting embodiments is the ability to recycle the PMW 12 and PCW 14 arising from the manufacture and/or use of disposable diapers.

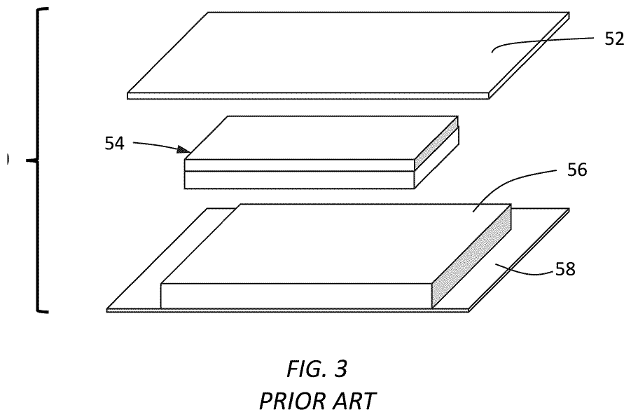

FIG. 3 schematically represents an exploded view of a typical disposable diaper 50. As illustrated in FIG. 3, the diaper 50 has several layers that work in a manner to effectively ensure that both urine and feces are transported away from the contact skin and kept locked inside the diaper 50 until disposal. The first outer layer (topsheet) 52 is intended to lie next to the skin of the person wearing the diaper 50 (i.e., a baby or incontinent adult). The main function of the topsheet 52 is to transport liquids quickly away from the skin. The topsheet 52 is commonly made of a nonwoven polymeric material, generally a blend of polyethylene and/or polypropylene. Below the topsheet 52, an acquisition layer 54 is provided that is commonly made of a blend of cellulose and a polyester. The acquisition layer 54 facilitates the movement of liquid away from the topsheet 52 and the wearer's skin and distributes the liquid more evenly across the entirety of an absorbent core 56 for efficient and maximal absorbency. The core 56 absorbs and prevents the liquid from re-contacting the wearer's skin. The absorbent core 56 is typically made of a mixture of superabsorbent polymers and fluff cellulose pulp sheathed inside a cellulose or polypropylene nonwoven layer. The cellulose portion of the core 56 functions to quickly absorb and transfer urine (and/or other liquids) to the superabsorbent polymers. Granules of the superabsorbent polymers, which are typically mainly polyacrylates, absorb and lock urine within its network structure, keeping the wearer dry. Below the absorbent core 56 is a second outer layer (backsheet) 58. The main function of the backsheet 58 is to prevent leakage. The backsheet 58 is typically made from a blend of polyethylene/polypropylene and/or other polymeric materials. Studies have found that the materials in typical disposable diapers are over 80% by weight cellulose pulp, superabsorbent polymers, polypropylene, and polyethylene (LDPE), with the remainder of the weight being a mix of small amounts of tape, elastic, adhesives, and other various synthetic polymers.

Several processes of recycling PCW and PMW disposable diapers to obtain recycled waste materials are known. These processes typically include various steps of shredding, cleaning, sterilizing, and drying the disposable diapers. The material components can then be further treated, separated, and/or processed into further forms appropriate for a desired use scenario. Typically, such recycling processes separate out the SAPs, other plastics, and pulps for further individualized uses as needed in the commercial marketplace. Some recycling processes create pellets. Other recycling processes use the recycled waste materials for energy production. Any recycling process suitable for transforming the used or waste disposable diapers into a curing agent material that includes superabsorbent polymer particles, and preferably also one or more of cellulosic particles and polypropylene fibers, may be used for providing the recycled PMW 12 and/or PCW 14 for the admixture 30 of the present invention. The process of recycling and transforming the PCW 14 and/or PMW 12 into the curing agent material 10 may be performed by any suitable party. It is foreseen that such recycling and transformation will typically be performed by another party separately from making the cement admixture 30 itself and that the recycled curing agent material 10 will be obtained by the manufacturer of the concrete admixture 30 already recycled and transformed.

Investigations leading to the development of the present invention have shown that that addition of PCW by itself results in a significant increase in 28-day compressive strength of concrete while addition of PMW containing SAPs displays the greatest swelling response and is thus most likely to perform as a typical internal curing agent in that it will mitigate the autogenous and drying shrinkage of the fresh concrete mixtures. Four representative samples (A, B, C, and D) of PMW and PCW materials from the manufacture and use of absorbent hygiene products were tested. Sample A was a PMW with approximately 20-80 μm particle sizes. Sample B was a PMW with approximately 60-600 μm particle sizes. Sample C was a PMW with approximately 20-600 μm particle sizes. Sample D was a PCW with particle sizes less than approximately 5000 μm. All four samples displayed some amount of swelling with fluid, indicating the hydrophilic nature of the waste materials. Samples A and B displayed the greatest absorption capacities. These samples also displayed significant desorption behavior (deswelling). The four samples A-D were then separately incorporated into mortar composed of type 1L cement, water (w/c=0.42), and sand (cement to sand ratio of 1:2.75). Water reducing admixture (a commercial polycarboxylate ether) was added at a dosage of 0.25% by weight of cement. The waste material samples were added at a dosage of 0.2% by weight of cement. Compressive strengths and flexural strength of test specimens were measured after 3 to 28 days of curing. The compressive strength showed significant increases in the 28-day peak strength values with the addition of the PMW and PCW materials compared to a control (reference) mortar that did not contain any waste materials. The flexural strength of the test specimens did not show any significant change with the addition of PMW and PCW materials.

Some examples of various grades of recycled and/or processed absorbent hygiene products that can be used as-received from commercial sources are discussed hereinafter. A PCW-only admixture is 100% PCW by weight of the admixture. A PMW admixture is 100% PMW by weight of the admixture. A mixed PMW admixture is a binary blend of PMW and PMW-mixed grades at all ratios. A PCW-PMW admixture is a ternary blend of PCW, PMW, and PMW-mixed grades at all ratios. Any of these as-received grades of recycled and/or processed absorbent hygiene products may be processed with a silica-based binder and/or silica-based grinder. In some embodiments, the admixture 30 may be formed of any one or a mixture of these grades recycled and/or processed absorbent hygiene products mixed with about 1 to about 80% silica-based binder and/or silicate-based grinder by weight of the admixture 30, more preferably with about 5 to about 50% silica-based binder and/or silicate-based grinder by weight of the admixture 30, and even more preferably with about 10 to about 30% silica-based binder and/or silicate-based grinder by weight of the admixture.

The admixture 30 can be incorporated into many different Portland cement concrete mixtures. One nonlimiting example is a typical Class C concrete mixture, containing Portland cement, water, fine and coarse aggregate, water-reducing admixture, and an air entraining agent, as well as the admixture 30. The admixture 30 may include any one or more of the grades of recycled and/or processed absorbent hygiene products with or without one or more of the silica-based binder and the silicate-based grinding aid. In some embodiments, the total dosage of the admixture 30 in the concrete mixture 40 by weight of the cementitious material (cement) 42 may be about 0.05 to about 20% admixture by weight of cement, more preferably about 0.1 to about 10% admixture by weight of cement, and even more preferably about 0.1 to about 5% admixture by weight of cement. The total admixture dosage could be added to the fresh concrete mixture directly, for example, by pouring from a bucket or a bag directly into the uncured concrete, or by means of a secondary delivery system, such as using the pre-measured dissolvable bags 32 made from a water-soluble plastic or organic material.

In some configurations and uses, admixtures 30 as disclosed herein are believed to improve on previously known solutions (LWA and SAP internal curing agents; silica fume; other shrinkage reducing and viscosity modifying admixtures) in one or more of the following ways.

The admixture 30 can be created from waste materials instead of virgin petroleum-derived materials. Reusing components from post-manufacturing and post-consumer waste related to the manufacture and use of absorbent hygiene products will be more sustainable and cost effective in the long term compared with using virgin fossil fuel-based materials. Disposable diapers and other absorbent hygiene products eventually account for about 12% (about 3.4 million tons) of all non-durable goods in municipal solid waste landfills, uniformly distributed across all populations in the United States. Thus, the valorization of absorbent hygiene products-related waste for use in concrete can reduce the amount of waste disposed in landfills.

Silica fume used within the admixture 30 disclosed herein can be delivered to the concrete mixture in a manner that is more controlled and less hazardous to construction workers. Due to its small size, dry silica fume is a significant inhalation hazard. However, when combined with materials derived from absorbent hygiene products plus a silica-based binder, larger particles for the admixture 30 disclosed herein are believed to be significantly less hazardous (i.e., no more than cement powder itself) and easier to incorporate (“batch”) into the cement mixtures.

The mixture of absorbent hygiene products and silica-based binder within the admixture 30 may act as a multi-functional admixture, displaying more effective and efficient performance than conventional internal curing agents (e.g., SAP, LWA), shrinkage reducing additives, viscosity modifying additives, and reinforcing polymer fibers, even when such additives are used alone or in combination, with and without silica fume.

As previously noted above, though the foregoing detailed description describes certain aspects of one or more particular embodiments of the invention, alternatives could be adopted by one skilled in the art. For example, the admixtures and their components could differ in appearance and construction from the embodiments described herein and shown in the drawings, functions of certain components of the admixtures could be performed by components of different construction but capable of a similar (though not necessarily equivalent) function, and various materials could be used in the fabrication of the admixtures and/or their components. As such, and again as was previously noted, it should be understood that the invention is not necessarily limited to any particular embodiment described herein or illustrated in the drawings.

1. An admixture for concrete comprising a mixture of a silica-based binder and recycled waste material comprising superabsorbent polymer particles and cellulosic particles, wherein the admixture is in a powder form.

2. The admixture of claim 1, wherein the recycled waste material comprises post-consumer waste and/or post-manufacturing waste comprising recycled absorbent hygiene products.

3. The admixture of claim 2, wherein the recycled absorbent hygiene products comprise recycled disposable diapers.

4. The admixture of claim 2, wherein the recycled absorbent hygiene products comprise the superabsorbent polymer particles, the cellulosic particles, and polypropylene fibers.

5. The admixture of claim 1, wherein the admixture is contained in a water-soluble container.

6. The admixture of claim 1, wherein the recycled waste material comprises polypropylene fibers.

7. The admixture of claim 1, wherein the powder form comprises dry particle aggregates of the silica-based binder and the recycled waste material.

8. The admixture of claim 7, wherein the dry particle aggregates have a diameter of about 100 to about 800 micrometers.

9. The admixture of claim 1, wherein the mixture further comprises a silica-based grinding aid.

10. The admixture of claim 1, wherein the silica-based binder comprises at least one of silicon dioxide particles, an organic silicate binder, an organosilane, and silica fume.

11. A concrete mixture comprising;
a cementitious material;
an aggregate; and
the admixture of claim 1.

12. A method of manufacturing an admixture for concrete, the method comprising:
obtaining a curing agent material containing a waste material comprising superabsorbent polymer particles and cellulosic particles;
forming a mixture of the curing agent material with a silica-based binder;
forming a dry powder from the mixture that dissolves and reacts when incorporated as an admixture into a fresh (wet) concrete mixture.

13. The method of claim 12, wherein the post-consumer waste and/or post-manufacturing waste further comprises polypropylene fibers.

14. The method of claim 12, wherein the post-consumer waste and/or post-manufacturing waste comprises recycled disposable diapers comprising the superabsorbent polymer particles, the cellulosic particles, and polypropylene fibers.

15. The method of claim 12, further comprising packaging the dry power in a water-soluble container.

16. The method of claim 15, wherein the water-soluble container comprises a dissolvable bag.

17. The method of claim 15, wherein the waste material has been recycled.

18. A method of making concrete, the method comprising:
mixing a cementitious material, an aggregate, water, and an admixture to form a fresh concrete mixture, the admixture being in a powder form and comprising a mixture of a silica-based binder and recycled waste material comprising superabsorbent polymer particles and cellulosic particles; and
curing the fresh concrete mixture, wherein the admixture absorbs and releases water during the curing.
